(19) United States
(12) Patent Application Publication
(10) Pub. No.: US 2013/0160623 A1
(43) Pub. Date: Jun. 27, 2013

(54) Table Saw Dust Cover

(71) Applicant: Brian Taylor, Chicago, IL (US)

(72) Inventor: Brian Taylor, Chicago, IL (US)

(73) Assignees: ROBERT BOSCH GMBH, Stuttgart (DE); ROBERT BOSCH TOOL CORPORATION, Broadview, IL (US)

(21) Appl. No.: 13/337,496

(22) Filed: Dec. 27, 2011

(51) Int. Cl. B26D 7/18; B27G 3/00; B23D 45/06

(52) U.S. Cl. 83/147; 83/162

(57) ABSTRACT

A power tool includes a table structure defining a blade slot, a frame supporting the table structure, a blade assembly mounted within the frame, and a carriage assembly. The blade assembly includes a blade positioned within the blade slot and a motor assembly to rotate the blade, in which the carriage assembly supports the motor assembly relative to the table structure. The carriage assembly defines a chamber within which said blade operates and a discharge chute for discharge of dust and debris from the chamber during operation of the blade. The bottom wall of the carriage assembly below said blade defines a plurality of openings that are sized to permit passage of the dust and debris. The openings may be sized to comply with finger probe test safety standards. In certain embodiments, the openings may be provided with a cover that is movable to expose or close the openings.

### TECHNICAL FIELD

The present disclosure relates generally to power saws, and particularly to power saws having a debris collection system.

### BACKGROUND

One type of cutting tool is a power saw that includes an electrical motor mounted below a work surface. Users frequently refer to this type of power saw as a table saw, because the work surface resembles a tabletop. The table has an opening that allows a portion of the cutting tool, such as a saw blade, to extend above the surface of the table. The blade, which is rotatably connected to the electrical motor, is movable relative to the surface of the table to enable a user of the table to make cuts of a particular depth or angle. For example, to adjust the height of the blade, a user may position a workpiece adjacent to the blade and then adjust the height of the blade such that the apex of the blade extends just above the thickest portion of the workpiece. To cut the workpiece, a user positions the workpiece on the table, such that a line representing the cutting path of the blade is aligned with a region of the workpiece to be cut, energizes the motor to rotate the blade, and moves the workpiece toward the rotating blade. As the blade cuts through the workpiece, it generates dust, chips, and other workpiece debris, which may be collected by a debris collection system.

Table saw debris collection systems, commonly referred to as dust collectors, direct the workpiece debris into a collection receptacle such as a porous bag or other suitable container. Additionally or alternatively, an external negative pressure source, such as a vacuum may be configured to draw the debris from a debris exit port of the table saw into a container. Some users, however, may desire a table saw having a dust collector, which functions effectively without a separate negative pressure source.

In some cases the user may not apply vacuum to the debris exit port, for example when a vacuum source is unavailable. In this instance, the debris may not be adequately discharged through the exit port while the blade is operating, which can lead to clogging of the debris collection system and even to binding of the blade. The user is then required to turn off the power tool and manually attempt to dislodge the debris through the exit port or disassemble the dust collection system to clean out the debris and dust. Accordingly, further developments in the area of table saw dust collection systems are desirable.

### SUMMARY

A power tool includes a table structure defining a blade slot, a frame supporting the table structure, a blade assembly mounted within the frame, and a carriage assembly. The blade assembly includes a blade positioned within the blade slot and a motor assembly to rotate the blade, in which the carriage assembly supports the motor assembly relative to the table structure. The carriage assembly defines a chamber within which said blade operates and a discharge chute for discharge of dust and debris from the chamber during operation of the blade. The bottom wall of the carriage assembly below said blade defines one or more openings that are sized to permit passage of the dust and debris and to comply with finger probe test safety standards. In certain embodiments, the openings may be provided with a cover that is movable to expose or close the openings. The cover may be pivotably, slidably or rotatably mounted to the carriage assembly to move between a position closing the openings and a position in which the openings are exposed for removal of debris therethrough.

In certain embodiments, the one or more openings include a plurality of elongated slots that extend along a substantial portion of the length of the bottom wall. In embodiments with a cover, the cover may be slidably mounted within certain of the elongated slots. In other embodiments, the openings include a plurality of arc segment openings. In these embodiments, the cover may be rotatably mounted over the openings with arc segment openings that coincide with the openings in the bottom wall when rotated to a certain position.

### BRIEF DESCRIPTION OF THE FIGURES

Features of the present disclosure should become apparent to those of ordinary skill in the art to which this device pertains from the following description with reference to the figures, in which:

FIG. 1 is a perspective view of a table saw.

FIG. 2 is an exploded view of certain components of the table saw of FIG. 1.

FIG. 3 is a side perspective view of the carriage assembly of the saw shown in FIG. 2, depicted with the cover removed.

FIG. 4 is an enlarged view of one embodiment of a dust discharge feature for use with the carriage assembly shown in FIG. 3.

FIG. 5 is an enlarged cross-sectional view of a further embodiment of a dust discharge feature for use with the carriage assembly shown in FIG. 3.

FIG. 6 is an enlarged view of another embodiment of a dust discharge feature for use with the carriage assembly shown in FIG. 3.

### DETAILED DESCRIPTION

For the purpose of promoting an understanding of the principles of the device described herein, reference is made to the embodiment(s) illustrated in the figures and described in the following written specification. It is understood that no limitation to the scope of the device is thereby intended. It is further understood that the device includes any alterations and modifications to the illustrated embodiment(s) and includes further applications of the principles of the device as would normally occur to one of ordinary skill in the art to which this device pertains.

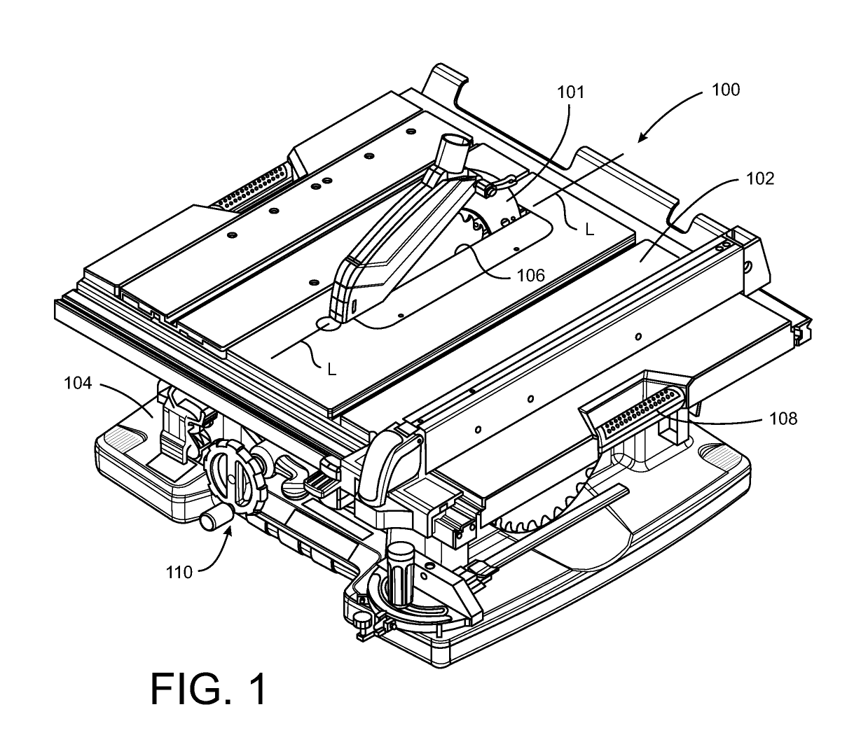

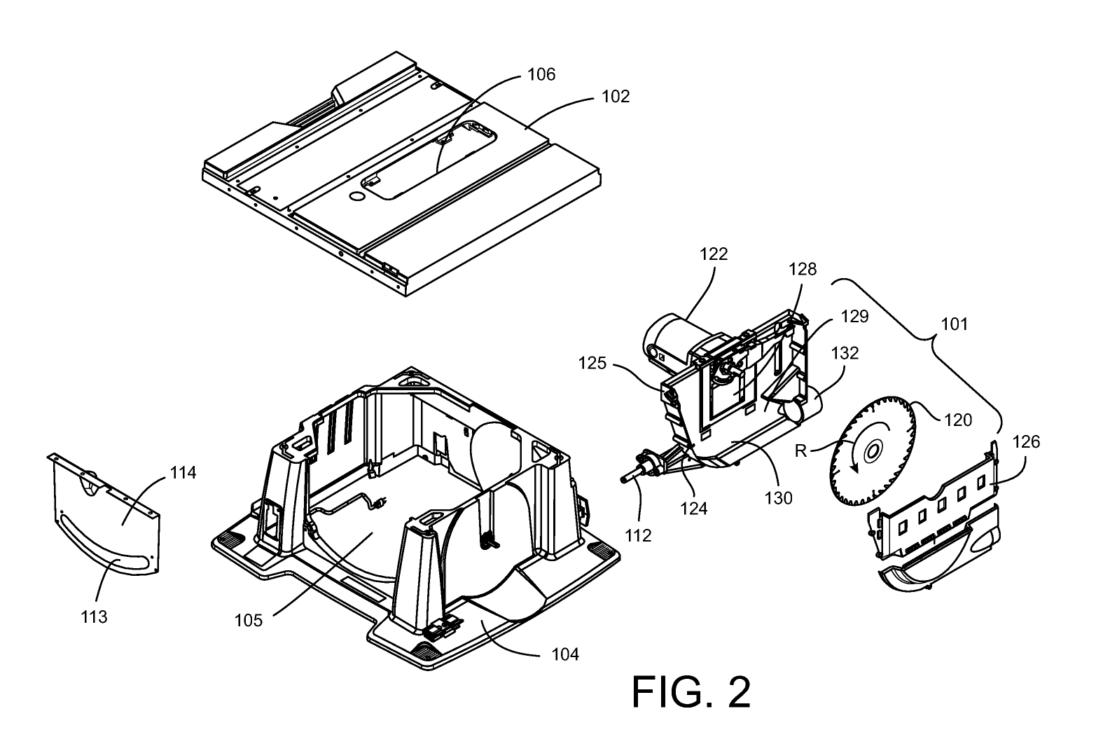

As shown in FIGS. 1 and 2, a power tool in the form of a table saw 100 includes a blade assembly 101, a table structure 102 and a frame 104. The table 102 includes an opening or slot 106 through which a top portion of the blade assembly 101 extends. The table 102 has a generally planar upper surface, which may be referred to as a work surface. The frame 104 is connected to a bottom portion of the table 102 and is configured to define an internal space 105 in which the bottom portion of the blade assembly 101 is positioned. In the embodiment of FIG. 1, the table structure 102 and frame 104 may be formed from sheet metal, plastic, aluminum, composite materials, or the like. The table 102 and/or frame 104 may include handles, such as handle 108, which enable a user to carry the table saw 100 conveniently.

In certain embodiments, the blade assembly 101 has a fixed position along the longitudinal axis L of the table 102 or along the length of the slot 106. In other embodiments, the blade assembly 101 may be mounted to a slide assembly (not shown) that enables the blade assembly longitudinally relative to the table 102, commonly referred to as a “push-pull” saw.

The blade assembly 101 of the table saw 100 includes an adjustment mechanism 110 for adjusting the angular and vertical position of the blade. The mechanism 110 is adapted to permit rotation of the blade assembly 101 about the longitudinal axis L so that the blade can make an oblique cut in the workpiece. The mechanism may be further adapted to raise and lower the cutting blade relative to the table 102 to adjust the depth of the cut into the workpiece.

As shown in FIG. 2, the blade assembly 101 generally includes a blade 120, an electrical motor assembly 122, and a carriage assembly 124 including a cover 126. The carriage assembly 124 includes a pivot mount 125 that is pivotably mounted to the carriage 104 or to the underside of the table 102 to permit pivoting of the blade assembly, and thus the blade 120, about the longitudinal axis L (FIG. 1). The motor assembly 122 is supported within a channel 128 in the carriage assembly configured to allow the motor assembly, and therefore the blade 120, to move up and down relative to the table 102 and slot 106. The blade 120 may be configured for rotary or reciprocating motion, depending upon the nature of the table saw 100, and the motor assembly 122 is configured to drive the blade in the rotary or reciprocating motion.

The adjustment mechanism 110 incorporates a mechanism for controlled pivoting of the carriage assembly 124 relative to the table 102, and for controlled up and down movement of the motor assembly 122 relative to the table, which ultimately provides for controlled positioning of the cutting blade 120. It can be appreciated that a variety of adjustment mechanisms may be utilized to provide the angular and up-down adjustments for the blade 120. For instance, a lead screw mechanism may be provided to move the motor assembly 122, and thus the blade 120, up and down relative to the carriage assembly 124 and thus relative to the table 102 and work surface. The angular adjustment mechanism may incorporate a locking pin, such as pin 112, engaged within a curved slot 113 in a side wall 114 of the frame 104. Other mechanisms are contemplated provided they are at least capable of adjusting the angle of the blade 120 relative to the table 102 and slot 106.

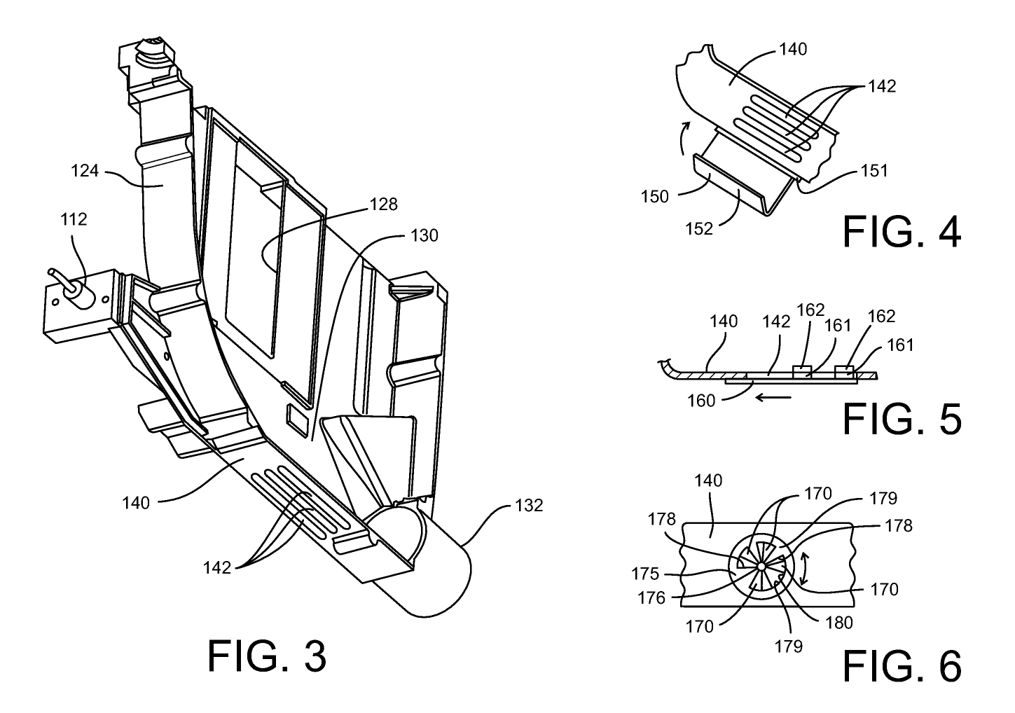

The carriage assembly 124 and cover 126 define a chamber 129 within which the blade 120 rotates when it is mounted to the motor assembly 122. The chamber 129 includes a discharge chute 130 defined at a lower portion of the chamber to direct dust and debris to an outlet 132, as shown in FIGS. 2 and 3. The chamber and discharge chute are configured to redirect dust and debris propelled by the rotation of the blade 120 in the direction R. Rotation of the blade can generate airflow that helps to further propel the debris along the discharge chute 130 to the outlet 132. It is also contemplated that suction may be provided at the outlet 132 to assist in clearing the dust and debris from within the chamber 129.

The carriage assembly 124 and more particularly the chamber 129 and chute 130, are configured to contain and convey the majority of the dust and debris when the blade 120 is operated. However, these features have their greatest utility when coupled to a vacuum or suction source at the outlet 132. In some cases, the user may not apply vacuum, such as when working outdoors or where a vacuum source is not available. While some of the dust and debris may be discharged from the open outlet 132, dust will typically tend to accumulate within the discharge chute 130. If the outlet 132 is clogged, the dust will continue to build up within the chamber 129 until the saw blade is impeded. The user must then find some way to remove the built up dust and debris, which involves shutting the power tool down and opening the carriage assembly 124 or poking an instrument through the outlet 132 to scrape out the dust and debris from the discharge chute 130. It can be appreciated that this method for clearing the carriage assembly can be time consuming and frustrating for the user.

In accordance with one aspect of the present disclosure, the carriage assembly 124 is provided with openings that allow passage of dust and debris from the carriage assembly while still protecting the user from the blade. Thus, in one embodiment shown in FIG. 3, the bottom wall 140 of the carriage assembly 124 includes a number of openings 142 that are sized to at least allow passage of dust generated by operation of the saw blade. The openings 142 are small enough to pass the standard finger probe test (EN61029) to ensure that the user's fingertips cannot contact the saw blade through the openings. Thus, in one embodiment the openings 142 may be in the form of elongated slots each having a width of less than 0.2 in. The slots may extend along substantially the entire length of the bottom wall 140.

The openings 142 may assume various configurations, provided that they have sufficient area to allow passage of at least saw dust and are sufficiently small to pass the finger probe test. In the embodiment shown in FIG. 3 the openings are elongated linear slots, but the openings could be curved or angled slots, or a series of circular or square perforations. The configuration of the openings may be further affected by the material and method of manufacturing the carriage assembly. For instance, elongated linear slots may be preferable for a molded plastic carriage, while drilled perforations may be preferable for a machined metal carriage.

In the illustrated embodiment the openings 142 are shown without any closure. Thus, the openings 142 remain open even when vacuum or suction is applied at the outlet 132. However, it may be desirable to close the openings when suction is used so that all of the dust and debris is ejected through the outlet 132. The present disclosure thus contemplates the addition of a movable closure for the openings.

In one embodiment, a movable door 150 is provided that is configured to cover the openings 142, as shown in FIG. 4. In one specific embodiment the cover 150 is mounted to the carriage assembly, such as at the bottom wall 140, by a hinge 151. The hinge 151 is configured so that the cover 150 can be pivoted between the position shown in FIG. 4 to a position covering the opening. The cover may be provided with a lip 152 that is configured to engage the carriage assembly 124 or cover 126 to hold the cover tightly against the openings 142. Suction applied at the outlet 132 may further help pull the cover against the openings. The cover 150 may be configured with a lip 152 on opposite sides that are configured for press-fit engagement to the carriage assembly, without the need for the hinge 151.

In another embodiment, a sliding cover 160 may be provided, as shown in FIG. 5. In this embodiment, the cover 160 may be provided with features that engage the carriage assembly that allow the cover to slide from a position blocking the openings 142 to a position substantially clear of the openings. Thus, in one specific embodiment, the cover 160 may be provided with prongs 161 that project into one or more of the slots 142. The prongs may be provided with lips 162 that engage the inside of the carriage assembly so that the cover is supported with the prongs extending through one or more slots. The prongs 161 may be arranged at one end of the cover 160 so that when the prongs are moved in the direction of the arrow in FIG. 5 toward one end of the slots 142 the cover 160 is substantially clear of the openings. Sliding the cover in the opposite direction closes the slots. The prongs can be configured for a close running fit between the cover and the openings to maintain as tight a seal as possible when the cover is closed. Again, suction applied through the outlet 132 may help pull the cover against the bottom wall 140 of the carriage assembly.

As an alternative to engaging within the slots themselves, the prongs 161 of the cover 160 may be arranged to engage grooves in the carriage assembly. For example, grooves may be provided in the side walls of the carriage assembly with the prongs on the cover configured to wrap around the bottom wall 140 to engage the grooves. With this construction, the prongs do not interfere with the openings 142. The grooves and prongs may be configured to ensure a close running fit between the cover 160 and the openings.

In a further embodiment, a rotating cover 170 may be provided as shown in FIG. 6. In this embodiment, the openings 178 are in the form of circular arc segments. The cover 170 is provided with complementary circular arc segment openings 178 that are sized to generally coincide with the openings 178 in the bottom wall 140 of the carriage assembly. The spaces 179 between the arc segments 178 of the cover 170 are sized to completely cover a respective opening 170. The cover is rotatably mounted to the bottom wall 140 at a pivot mount 176 so that the cover 175 can be rotated in the direction of the arrows to open or close the openings 170. A handle 179 may be provided on the cover 175 to facilitate rotation of the cover. The cover 175 and pivot mount 176 may be configured to provide a close running fit between the cover and the bottom wall 140 to ensure as tight a seal over the openings 170 as possible.

The devices and apparatuses described herein has been illustrated and described in detail in the figures and foregoing description, the same should be considered as illustrative and not restrictive in character. It is understood that only the preferred embodiments have been presented and that all changes, modifications, and further applications that come within the spirit of the device described herein are desired to be protected.

What is claimed is:

1. A power tool comprising:
a table structure including a work surface and defining a blade slot;
a blade assembly support on said table structure including;
a blade operably positioned within said blade slot;
a motor assembly coupled to said blade to operate the blade; and
a carriage assembly supporting said motor assembly and mounted to said table structure, said carriage assembly defining a chamber within which said blade operates and a discharge chute for discharge of dust and debris from said chamber during operation of said blade, said carriage assembly further including a bottom wall below said blade, said bottom wall defining at least one opening in communication with said chamber, said at least one opening sized to permit passage of the dust and debris.

2. The power tool of claim 1, wherein said at least one opening includes a plurality of elongated slots, each slot sized to permit passage of the dust and debris.

3. The power tool of claim 2, wherein said elongated slots have a width of less than about 0.2 inches.

4. The power tool of claim 2, wherein said bottom wall has a length generally parallel to a length of said discharge chute, and said elongated slots have a length substantially equal to the length of said discharge chute.

5. The power tool of claim 1, wherein said carriage assembly further includes a cover movably mounted to said carriage assembly to cover said at least one opening in a first position and to uncover said at least one opening in a second position.

6. The power tool of claim 5, wherein said cover is pivotably mounted to said carriage assembly.

7. The power tool of claim 5, wherein said cover is slidably mounted to said carriage assembly.

8. The power tool of claim 5, wherein said cover is rotatably mounted to said carriage assembly.

9. The power tool of claim 1, wherein said at least one opening is sized to comply with finger probe test safety standards.
